(19) United States
(12) Patent Application Publication
(10) Pub. No.: US 2026/0134194 A1
(43) Pub. Date: May 14, 2026

(54) SYSTEM AND METHOD FOR AUTO TRANSCRIPTION OF VIDEOS

(71) Applicant: Honeywell International Inc., Charlotte, NC (US)

(72) Inventor: Taher Saifuddin Kundawala, Thane West (IN)

(21) Appl. No.: 18/944,082

(22) Filed: Nov. 12, 2024

(51) Int. Cl. G06F 40/166; G06F 3/0482; G06F 3/0484; G06F 40/58; G06V 20/40

(52) U.S. Cl. CPC G06F 40/166; G06V 20/47; G06F 3/0482; G06F 3/0484; G06F 40/58

(57) ABSTRACT

A system and method for transcribing videos is disclosed. The system 102 comprises a storage 106 and at least one processor 104 coupled to the storage 106. The at least one processor configured to play a video pertaining to an application. Further, the processor 104 is configured to identify, using a trained model, one or more actionable items present in a Graphical User Interface (GUI) being displayed in the video. Further, the processor 104 is configured to determine, using the trained model, at least one user input action performed on at least one actionable item in the GUI in the video. Further, the processor 104 generates a transcription corresponding to the at least one user input action. Further, the processor 104 stores the transcription in transcription summary data 108 corresponding to the video in the storage 106.

### TECHNICAL FIELD OF THE INVENTION

The present subject matter relates to transcription system and, more particularly, to systems and methods to provide auto transcription of different types of application/training videos.

### BACKGROUND OF THE INVENTION

In the process of creating instructional or demonstration videos for clients, the content often focuses on visually depicting a user navigating through software or a web application. These videos typically present step-by-step actions performed within the interface, highlighting various features or demonstrating how specific tasks are completed. However, these videos often do not include any form of audio commentary or accompanying textual explanations, which can limit their effectiveness for certain audiences.

By incorporating a textual summary of the user's interactions with the software, the videos could significantly improve in several key areas. First, this enhancement would improve accessibility, making the content more usable for individuals with disabilities—particularly those who are hard of hearing, deaf, or have cognitive challenges that make it easier to follow along with written instructions. Additionally, this textual layer could serve as a valuable form of documentation, providing users with a written guide that they can reference later, further complementing the video format.

Moreover, these textual summaries would be especially useful for creating a comprehensive user guide for the software or web application. By breaking down each action and including clear, concise descriptions, viewers could better understand the flow of the application and how to effectively use its features.

Therefore, there is need for creating instructional or demonstration videos for clients with textual summary.

### SUMMARY OF THE INVENTION

The present subject matter provides systems and methods for processing utility bills having distinct formats.

In an embodiment, a system for transcribing videos is disclosed. The system comprises a storage and at least one processor coupled to the storage. The processor is configured to play a video pertaining to an application. The processor is further configured to identify, using a trained model, one or more actionable items present in a Graphical User Interface (GUI) being displayed in the video. Further, the processor is configured to determine, using the trained model, at least one user input action performed on at least one actionable item in the GUI in the video. Yet further, the processor is configured to generate a transcription corresponding to the at least one user input action. The processor is further configured to store the transcription in transcription summary data corresponding to the video in the storage.

In some embodiments, the processor is further configured to determine one or more GUI actions associated with the at least one user input action displayed in the video by analyzing a plurality of GUI actions occurred within a predefined time period from the at least one user input action. The processor is further configured to generate one or more GUI action transcriptions corresponding to the one or more GUI actions. The processor is further configured to store the one or more GUI action transcriptions in the transcription summary data corresponding to the video in the storage.

In some embodiments, the processor may be configured to render the transcription summary data on a display device. The transcription summary data comprises a plurality of transcriptions and/or a plurality of GUI action transcriptions. Further, a plurality of edit options corresponding to the plurality of transcriptions and/or the one or more of GUI action transcriptions are rendered along with the plurality of transcriptions and/or the one or more GUI action transcriptions on the display device. The processor may be further configured to receive a selection of an edit option from the plurality of edit options. The processor may be further configured to permit edit/deletion of the transcription/GUI action transcription corresponding to the selected edit option. The processor may be further configured to edit/delete the transcription/GUI action transcription corresponding to the selected edit option based on a user input.

In some embodiments, the processor may be configured to render the transcription summary data on a display device. The processor may be further configured to display a list of languages in a language translation menu on the display device. The processor may be further configured to receive a selection of a language from the list of languages. The processor may be further configured to translate the transcription summary data based on the selected language to obtain translated transcription summary data. The processor may be further configured to store the translated transcription summary data in the storage.

In some embodiments, the processor may be configured to determine a domain of the application based on metadata associated with the video, wherein the metadata includes information about the domain of the video. The processor may be further configured to access the storage, wherein the storage comprises one or more trained models corresponding to one or more domains. The processor may be further configured to select the trained model from the one or more trained models based on the domain of the application.

In some embodiments, the processor may be configured to capture a timestamp corresponding to the at least one user input. The processor may be configured to display the timestamp along with the transcription during a rendering of the transcription summary data on a display device. The processor may be configured to receive a user input on the displayed timestamp. Further, the processor may be configured to play the video from a time instant corresponding to the timestamp.

In some embodiments, the user input action may comprise at least one of: a mouse clicks, a keyboard input, a click operation performed based on a voice input, and a data entry performed based on a voice input.

In another embodiment, a method for transcribing videos is disclosed. The method comprises playing a video pertaining to an application. The method further comprises identifying, using a trained model, one or more actionable items present in a Graphical User Interface (GUI) being displayed in the video. The method further comprises determining, using the trained model, at least one user input action performed on at least one actionable item in the GUI in the video. The method further comprises generating a transcription corresponding to the at least one user input action. The method further comprises storing the transcription in transcription summary data corresponding to the video in the storage.

In yet another embodiment, a computer-readable medium having computer-executable instructions stored thereon is disclosed. The computer-executable instructions, when executed by a processing system, cause the processing system play a video pertaining to an application. Further, the computer-executable instructions cause the processing system to identify, using a trained model, one or more actionable items present in a Graphical User Interface (GUI) being displayed in the video. Further, the computer-executable instructions cause the processing system to determine, using the trained model, at least one user input action performed on at least one actionable item in the GUI in the video. Further, the computer-executable instructions cause the processing system to generate a transcription corresponding to the at least one user input action. Further, the computer-executable instructions cause the processing system to store the transcription in transcription summary data corresponding to the video in the storage.

The present subject matter provides systems and methods for auto transcription of different types of training videos. By implementing the proposed approach, a broader means of delivering application videos to a diverse audience may be offered, accommodating a wider range of customers and users. Additionally, it would streamline the process by eliminating the need to manually generate textual content for both the application and any new features introduced. Utilize a video classification model to train on the dataset, detecting actions such as button clicks, data alterations in fields, and URL navigation. The proposed approach would learn to analyze mouse activity and precisely interpret the user's actions.

This summary is provided to describe select concepts in a simplified form that are further described in the detailed description. This summary is not intended to identify key or essential features of the claimed subject matter, nor is it intended to be used as an aid in determining the scope of the claimed subject matter.

### BRIEF DESCRIPTION OF DRAWINGS

Embodiments of the subject matter will hereinafter be described in conjunction with the following drawing figures, wherein like numerals denote like elements, and:

FIG. 1 illustrates an environment implementing a video transcription system, according to one or more embodiments of the present disclosure.

FIG. 2 illustrates a use case depicting operation of the video transcription system, in accordance with one or more embodiments of the present subject matter.

FIG. 3 illustrates a use case depicting operation of the video transcription system, in accordance with one or more embodiments of the present subject matter.

FIG. 4 illustrates a use case depicting operation of the video transcription system, in accordance with one or more embodiments of the present subject matter.

FIG. 5 illustrates a flowchart of a method for transcribing videos, according to one or more embodiments of the present disclosure.

FIG. 6 illustrates a flowchart of a method for transcribing videos, by determining and transcribing GUI actions associated with user input action according to one or more embodiments of the present disclosure.

FIG. 7 is a flowchart illustrating a method for translating transcription summary data into different languages, according to one or more embodiments of the present disclosure.

FIG. 8 is a flowchart illustrating a method for capturing timestamps corresponding to user input actions and using those timestamps to enable playback of the video from specific time instants, according to one or more embodiments of the present disclosure.

Further, skilled artisans will appreciate that elements in the drawings are illustrated for simplicity and may not have been necessarily been drawn to scale. For example, the flow charts illustrate the method in terms of the most prominent steps involved to help to improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having benefit of the description herein.

### DETAILED DESCRIPTION OF INVENTION

The following description should be read with reference to the drawings, in which like elements in different drawings are numbered in like fashion. The drawings, which are not necessarily to scale, depict examples that are not intended to limit the scope of the disclosure. Although examples are illustrated for the various elements, those skilled in the art will recognize that many of the examples provided have suitable alternatives that may be utilized.

As used in this specification and the appended claims, the singular forms “a”, “an”, and “the” include the plural referents unless the content clearly dictates otherwise. As used in this specification and the appended claims, the term “or” is generally employed in its sense including “and/or” unless the content clearly dictates otherwise.

It is noted that references in the specification to “an embodiment”, “some embodiments”, “other embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is contemplated that the feature, structure, or characteristic may be applied to other embodiments whether or not explicitly described unless clearly stated to the contrary.

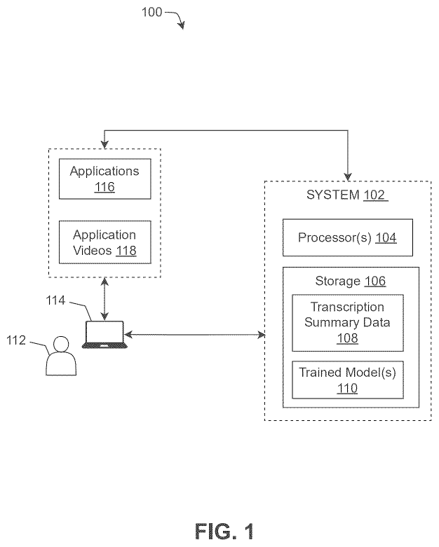

FIG. 1 illustrates an environment 100 implementing a video transcription system 102, hereinafter interchangeably referred to as “the system 102” or “the transcription system 102,” for transcribing user input actions and related Graphical User Interface (GUI) actions shown in a video pertaining to an application 116. In an embodiment, the system 102 may identify user input actions performed on actionable items present in the GUI of the application 116. In an example, the actionable items may be buttons, icons, links, text fields, dropdown menus, etc.

In an embodiment, the user input action may be understood as any interaction

initiated by a user 112 in an application video 118, which may be captured in the video for transcription. The user input action may include but not limited to clicking on a button or icon, typing into a text field or search bar, selecting options from a dropdown menu, dragging and dropping items within the application video 118, etc. Further, the GUI action may be understood as an interface related actions in the application video 118 prior to or subsequent to the user input action. Examples of GUI actions may include a button being highlighted when clicked, a form field updating or showing new text as it is typed, an item being moved across the screen after a drag-and-drop action, a dropdown menu expanding and displaying available options, etc.

In an example, the user input action may be clicking on a “Submit” button in the

application video 118. Further, the GUI Action may be “Submit” button gets highlighted to indicate that it has been pressed, and a confirmation message appears after the form submission. Further, in an example, the use input action may be selecting an option from a dropdown menu in the application video. The GUI action may be a dropdown menu expands to show available options, and the selected option is highlighted once clicked.

In an embodiment, the application video 118 may be a tutorial explaining how to

use one or more features of the application 116. For instance, a video pertaining to a travel application may illustrate how to raise complaints related to travel bookings using the travel application. By transcribing the user input actions and the related GUI actions may help users learn how to navigate applications more effectively. By implementing the proposed approach, a broader means of delivering application videos to a diverse audience may be offered, accommodating a wider range of customers and users. Additionally, it would streamline the process by eliminating the need to manually generate textual content for both the application and any new features introduced. In some examples, the system 102 may be utilized by enterprises, app developers, E-commerce platforms, etc. The system 102 may be implemented in various environments, such as desktop computers, mobile devices, cloud platforms, and integrated systems such as kiosks, automated teller machines (ATMs), or point-of-sale (POS) systems, etc.

In an example, the application 116 may include design tools, video editing software, project management systems, or even gaming interfaces, etc. In an example, the application video 118 related to the application 116 may be a recording of a user interacting with the software, showing step-by-step actions like clicking, typing, or selecting menu options, etc. In one example, an application video 118 may be a tutorial video showing how to edit a short film using editing tool which is an application 116. The video 118 demonstrates the user importing footage, cutting clips, applying transitions, and adding music. Further, in an example, the application video 118 may be a recorded session showing how to use a mobile banking application 116. The video shows a user logging in with biometric authentication, checking their account balance, and making a money transfer.

The system 102 includes at least one processor 104 and a storage 106. The processor 104 is operably coupled to the storage 106 and is configured to process video data, perform action recognition, and generate transcriptions. The storage 106 may include a variety of storage mediums, such as local storage, network-attached storage (NAS), or cloud storage, and may store videos, transcription data, models, and metadata.

The processor 104, in some examples, may be implemented or realized as general purpose processors, a content addressable memory, a digital signal processor, an application specific integrated circuit, a field programmable gate array, any suitable programmable logic device, discrete gate or transistor logic, discrete hardware components, or any combination designed to perform the functions described here. In some examples, the processor 104 may be realized as microprocessors, controllers, microcontrollers, or state machines. In some examples, the processor 104 may be realized as a combination of computing devices, such as, a combination of digital signal processors and microprocessors, a plurality of microprocessors, one or more microprocessors in conjunction with a digital signal processor core, or any other such combination/configuration. In some embodiments, one or more processors, such as the processor 104 or equivalents thereof, may be provided for performing operations thereof, as described herein.

The storage 106 comprises one or more non-transitory computer-readable storage media, including but not limited to volatile storage media such as random-access memory (RAM), registers, cache, etc., as well as non-volatile storage media such as read-only memory (ROM), hard disk drives, solid-state drives, flash memory, optical storage devices, and so forth. Furthermore, the storage 106 may encompass computer-readable storage media that are distributed across a plurality of physical computing devices connected via a network, such as storage clusters within public, private, or hybrid cloud-based environments. In some embodiments, the storage 106 may be provisioned with software components that facilitate the system 100 in executing functionalities disclosed herein. These software components typically consist of program instructions executable by the processor 104, organized into software applications, virtual machines, software development kits, toolsets, or similar structures. Furthermore, the storage 106 may be configured to maintain data within one or more databases, file systems, or equivalent data structures. The storage 106 may also be implemented in other forms and/or configured to store data using alternative methods.

As mentioned above, the system 102 may be configured to transcribe the user input

actions and the related GUI actions shown in the video pertaining to the application 116. In operation, the processor 104 may play an application video 118 related to one of the applications 116. The system 102 may identify user input actions performed on actionable items present in the GUI of the application 116. In an embodiment, the user 112 intending to transcribe a video may utilize the services of the system 102. Accordingly, the user may run the system 102 if provided on a user device 114 or otherwise connect to the system 102 if not provided on the user device 114.

In an embodiment, the system 102 may be installed on the user device 114. In an

alternative embodiment, the system 102 may not be installed locally on the user device 114 but rather hosted on a cloud server. In such cases, the user 112 may connect to the system 102 via the internet, typically using a web browser or an API. For example, an organization with multiple users may host the system 102 on a cloud infrastructure, allowing users 112 from various locations to access the transcription service remotely. In this case, the system 102 interacts with the application 116 hosted either locally on the user's device 114 or remotely in the cloud.

Further, after connecting with the system 102, the user 114 may provide the

application video 118 pertaining to the application 116 which is to be transcribed as an input to the system 102. In an example, the application 116 may run on the user device 114 which may be PC, laptop, mobile, etc. In an example, the user device 114 may be a display device 114. The display device 114 may be any computing device, such as a desktop monitor, tablet, or smartphone, etc. In an embodiment, when the system 102 is running on the user device 114, the user 112 may provide the application video 118 by selecting a file stored locally on their device 114. For example, the user 112 may select a video file saved on their user device 114, such as “C:\Videos\ApplicationDemo.mp4” for the system 102 to transcribe said video. Further, in an embodiment, if the system 102 is cloud-based, the user 112 may upload an application video 118 from a cloud storage service, such as Google Drive or Dropbox. For instance, the user 112 may provide a file path from cloud storage, such as “https://drive.google.com/ApplicationDemo.mp4,” enabling the system 102 to access and transcribe the video.

In some embodiments, the system 102 may capture user actions directly from a live

session of a web-based application. For example, the user 112 may be using a cloud-based system 102 through a web browser. The system 102 may record the user's real-time actions, such as filling in customer details or clicking on menu options, and then transcribe these actions without the need for a pre-recorded video file. This live recording feature may be particularly useful in training or demonstration scenarios where real-time interaction is required. Further, in an embodiment, the user 112 may provide videos captured from enterprise applications hosted on a central server. Such application videos 118 may be stored on the server or network-attached storage (NAS) within an organization's infrastructure. For instance, the user 112 may provide the system 102, a file path like “\ServerName\Videos\ApplicationDemo.mp4,” allowing the system 102 to access the video over the network. This may be used in organizations where multiple users access centrally hosted applications, and training or audit videos are generated and stored for later transcription.

In an embodiment, once the system 102 has the application video 118 provided by the user 112, the processor 104 in the system 102 may identify actionable items present in the GUI of the application 116 as they appear in the application video 118. The actionable items may refer to elements in the GUI on which user input actions may be performed. For example, the actionable items may include, but are not limited to, buttons, text boxes, dropdown menus, checkboxes, or other interactive elements that may be manipulated by a user within the application video 118. The system 102 may recognize these actionable items as are interacted with in the application video 118 and transcribe the corresponding user input actions.

In some examples, the processor 104 may use a trained model 110, such as a deep learning model, to recognize actionable items like buttons, menus, text boxes, and other GUI components. For instance, in an example, the processor 104 detects a “Submit” button displayed within the GUI of the video 118 as an actionable item. In an example, the “Submit” button may be clicked by the user 112. The trained model 110 may be pre-trained on a large dataset of GUI components and user actions to enhance its recognition capabilities across different application domains. Further, in an example, the trained model 110 may be implemented using AI techniques, such as gesture recognition, to identify user input actions.

Once the processor 104 detects the user input action, the processor 104 may generate a transcription corresponding to the action. For instance, if the user 112 enters login details in a field and clicks the “Submit” button, the transcription may state, “enter login details and click the Submit button.” In another example, if the user 112 entered text into a search field, the transcription may state, “enter desired text to be searched in the search field.” The generated transcription is stored in transcription summary data 108, which is saved in the storage 106 of the system 102.

In an example, the processor 104 may continuously monitor user actions in the application 118, detecting user input events such as button clicks, text entry, dropdown selections, and more. For each detected action, the processor 104 may generate a corresponding transcription that describes the action in a simple, readable format, which are saved in the transcription summary data 108.

In some embodiments, the processor 104 may analyze additional context in the application video 118 by determining one or more GUI actions associated with the user input action. In an embodiment, one or more GUI actions associated with the user input action may be either prior to the user input action or subsequent to the user input action. In an embodiment, one or more GUI actions may be the actions done prior to the user input actions. Further, in an embodiment, one or more GUI actions may be the actions done subsequent to the user input actions.

For instance, after a user clicks the “Submit” button, the processor 104 may analyze subsequent GUI actions, such as form submission or page navigation, within a predefined time period. The processor 104 generates GUI action transcriptions corresponding to these actions, such as “Form submitted successfully” or “Navigated to confirmation page,” and stores them in the transcription summary data 108.

For instance, after a user 112 may enter a query into a search bar and presses the “Enter” key, the processor 104 may analyse subsequent GUI actions, such as displaying search results, within the predefined time period. The processor 104 may generate GUI action transcriptions corresponding to these actions, such as “Search query submitted: “best restaurants” or “Displaying search results,” and stores them in the transcription summary data 108.

In some examples, after the user 112 clicks the “Submit” button on a form without completing all required fields, the processor 104 may analyse subsequent GUI actions, such as displaying an error message, within the predefined time period. The processor 104 generates GUI action transcriptions corresponding to these actions, such as “Form submission failed: Required fields not completed” or “Error message displayed: Please fill in the required fields,” and stores them in the transcription summary data 108.

Further, consider an example where the video of using an online shopping application provided to the system 102 for transcription. In the video, before the user 112 clicks any “Submit” button or “Add to cart button” for a particular object, the processor 104 may analyse GUI actions done before the user input action. For example, the processor 104 may analyze that the user 112 hovers over an “Add to Cart” button. As the user hovers the mouse over the button, the button color changes to indicate that it is clickable. The processor 104 generates GUI action transcriptions corresponding to this action as “highlighted add to cart’ button.” Further, the processor 104 may analyze that a small tooltip appears above the button saying, “click to add this item to your cart.” The processor 104 generates GUI action transcriptions corresponding to this action as “displayed tooltip: click to add this item to your cart.” Further, the processor 104 may analyse that the application 116 may check the availability of the item in real-time to ensure it's in stock. The processor 104 generates GUI action transcriptions corresponding to this action, “checked inventory status.” In said examples, the GUI actions happen prior to the user actually clicking any button or adding the item to the cart.

In some examples, the system 102 may be transcribing a video of a user 112 booking a ticket, and capturing the GUI actions both prior to and subsequent to specific user input actions within a single frame of the application video 118 for transcribing. In an example, the user 114 is interacting with a flight booking application 118 to select a flight and make a reservation. In this specific video frame, the user 112 is about to select a departure date from a calendar interface within the application video 118.

In an example, before the user 112 clicks specific date on the calendar (e.g., October 15th), the application 116 may initiate a series of GUI actions in preparation which includes highlighting available dates, pre-selecting a suggested date based on user preferences or search history, tooltip for selected date, i.e., when the user 112 hovers over a date, a tooltip pops up displaying more information (e.g., “Low fare: 500” or “Flights available: 5”), loading dynamic pricing, i.e. when the user 112 hovers over various dates, the application 116 may be loading real-time dynamic pricing data. Said GUI actions may be happening in the background without any explicit user input action for selecting any specific date. In an example, the processor 104 may transcribe said prior actions as: highlighted available flight dates in the calendar, pre-selected the cheapest suggested date, displayed tooltip having low fare: 500 or loaded real-time dynamic pricing for displayed dates.

In an example, after the user 112 clicks on the specific date (e.g., October 15th), the processor 104 may analyse subsequent GUI actions, such as confirming date selection, updating flight results, displaying price breakdown, enabling the “Continue” button. Accordingly, the processor 104 generates GUI action transcriptions corresponding to these actions as, “highlighted October 15th as selected date”, “displayed available flight options for October 15^{th}”, “updated price breakdown for selected date”, or “enabled continue button to proceed with booking.”

In an embodiment, the predetermined time may refer to a specific window of time during which the processor 104 is programmed to analyse and capture subsequent actions in the GUI following the user input and analyse and capture actions in the GUI prior the user input. For example, after the user 112 may perform an input action—such as clicking a button, submitting a form, or navigating to another page—the processor 104 may begin monitoring the application's 118 responses. For example, prior the user 112 may perform an input action—such as hovering by the user 112 on the different entries of drop-down menu, actions performed by the application 116 in real time, displaying of a tooltip-the processor 104 may begin monitoring the application's 118 responses. The predetermined time may serve as a limit within which the processor 104 may look for any prior to or subsequent actions triggered by the user's input.

Considering an example where the predetermined time may be set to 5 seconds. After a user 112 clicks the “Submit” button on a form, the processor 104 tracks the application's 118 response. Within this 5-second window, the processor 104 may detect the following GUI actions, such as at 0.5 seconds after the click: The form validation starts, at 1.5 seconds after the click: An error message appears stating that required fields are missing, and at 2 seconds after the click: The error message prompts the user to complete the form. In this case, all these actions occur within the predetermined time and may be captured by the processor 104 for generating the transcription. Once 5 seconds pass, any further actions such as the user 112 interacting with the form again would not be considered unless the user 112 may perform another input action.

Further considering an example, where the predetermined time may be set to 5 seconds. the predetermined time window is the time limit for the system 102 to capture any actions that happen before or after the user's input. If the user clicks a “Submit” button, the system 102 observes how the application responds during the next 5 seconds, capturing events such as form validation, error messages, etc. Additionally, the system 102 may look at actions right before the click, like the user hovering over certain menu items or interacting with tooltips. Accordingly, the system 102 may perform transcription of the actions performed with the predetermined time window of 5 sec.

In one example, the predetermined time period may be set by the system 102 or Application 116 configuration. The predetermined time period may be defined as part of the system's 102 settings or in the code governing the behavior of the processor 104. Developers or system administrators may configure the predetermined time period based on the nature of the application 116. For example, an application 116 with complex tasks that require longer loading times may have a longer time window, while a simpler app may use a shorter period.

Further, in an example, the predetermined period may be dynamically adjusted based on real-time conditions. For example, if the system 102 may detect that certain operations are slower due to server load or network latency, it could automatically extend the time period to ensure all relevant actions are captured.

In some embodiments, the processor 104 may be capable of rendering the transcription summary data 108 on the display device 114, as part of a GUI. The transcription summary data 108 may include multiple transcriptions and GUI action transcriptions, which are presented to the user 112 for review and editing. To enable easy modification of the transcriptions, the processor 104 may display a plurality of edit options 310 alongside the transcriptions 306 and GUI action transcriptions 308 on the display device 114. The edit options 310 allow users to select, edit, or delete any transcription or GUI action transcription. For example, if a transcription contains an error or requires modification, the user 112 may select the corresponding edit option to correct or remove the transcription. The processor 104 may then updates the transcription summary data 108 based on the user's input.

In one example, the edit option 310 may appear as small icons such as a pencil icon for editing or a trash bin for deleting next to each transcription. Once the user 112 may select the edit option 310, the transcription text 306, 308 may turn into an editable text box where the user 112 may manually correct or modify the transcription text 306, 308. After making changes, the processor 104 may prompt the user 112 to confirm or save the edits, ensuring that any modifications to the transcription summary data 108 are intentional. The processor 104 may updates the transcription summary data 108 in real-time as the user 112 makes edits, ensuring that the system 102 may remain synchronized with user actions and maintains an accurate record of transcriptions.

In an alternative embodiment, the processor 104 may display a language translation menu 404 on the display device 114, where a list of available languages 402 is shown. In an example, the user 112 may select a desired language from the list to translate the transcription summary data 108 into that language. The processor 104 may then performs a translation of the transcription summary data 108, using an appropriate translation model, and stores the translated transcription summary data 108 in the storage 106. For instance, if the user 112 selects French, the processor 104 may translate the English transcription into French and render it on the display device 114.

In an embodiment, the processor 104 may utilize the appropriate translation model to convert the transcription summary data 108 into the desired language. In an example, the translation model may be a built-in translation engine. The built-in translation engine may be a pre-configured software component integrated into the system 102. This engine can be based on various algorithms like neural machine translation (NMT) or rule-based translation. For example, NMT may be a sophisticated AI-driven method that processes language translations by learning patterns from large datasets. It would ensure translations are contextually accurate and grammatically sound. Further, in an example, the built-in translation engine may be a third-party translation service. The system 102 may also integrate with external translation APIs, such as Google Translate or Microsoft Translator, which offers reliable multilingual translation services.

Further, in an embodiment, the language translation menu 404 contains a list of available languages 402 that user 112 may choose from. The processor 104 may allow this list to be customizable and adaptable to user preferences, geographical regions, custom language support, etc. For example, the user 112 may have personal preferences for certain languages, which can be saved in their profile settings. For example, if a user frequently selects French, the system 102 may display French at the top of the language list or even set it as the default translation option. Further, in an example, the system 102 may detect the user's location via their IP address or device settings and automatically prioritize languages commonly spoken in that region. For instance, if the user 112 may access the device 114 from Canada, where both English and French are official languages, the language list may present these two languages at the top, making it more convenient for the user 112 to select. Further, in an example, the applications 116 may be pre-configured with certain languages to appear first based on their business needs. For example, if the application 116 may designed for global customers, it may prioritize widely spoken languages such as English, Spanish, Mandarin, and Arabic in the list.

In an alternate embodiment, the processor 104 may store both the original transcription summary data 108 and the translated transcription summary data. The storage 106 may allow for multiple language versions of the transcription data 108 to be saved side by side. Users can easily switch between languages without losing any data.

Further, in an embodiment, the system 102 may also determine the domain 502 of the application 116 based on metadata associated with the application video 118. The metadata may include information about the video 118, such as the application type, category, or user interaction context. Based on the domain, the processor 104 may access the multiple trained models 110 corresponding to different domains. The processor 104 may then select the appropriate trained model 110 for analysing the application video 118 based on the domain. For example, if the application belongs to the “e-commerce” domain, the processor 104 may select a model trained for e-commerce user interactions. In another example, the processor 104 may detect that the video 106 relates to a healthcare application based on the metadata 504. The processor 104 may select a trained model 110 specialized in healthcare application interfaces and user interactions, ensuring accurate recognition of actionable items and user input actions in that domain.

In an example, the system 102 may collect metadata automatically during the creation or upload of the application video 118. In an example, the metadata may be derived from the application's internal tagging system, its file properties, or through user-provided details during the video upload process. Further, processor 104 may access a repository of pre-trained models 110 (not shown in the figure), each designed for a specific domain. Said models may be trained using machine learning techniques like supervised learning, where each model is trained on large datasets specific to its domain. For instance, the e-commerce model would be trained on videos and interactions from various shopping websites, while the healthcare model would be trained on medical applications and patient management systems. Once the metadata is analysed, the processor 104 may dynamically selects the appropriate model based on the domain. In an embodiment, the selection process may ensure that the system 102 may apply the most relevant model for the application video 118, leading to more accurate analysis of user interactions for better transcription of the videos 118.

Further, in an embodiment, the system 102 may support the generation of timestamps corresponding to each user input action detected in the application video 118. For instance, the processor 104 may capture the exact time when a user 112 may click a button or enters text in the GUI and generates a timestamp. Said timestamp may be displayed alongside the transcription 306, 308 in the transcription summary data 108 when rendered on the display device 114. For example, the transcription might read “User clicked Submit button” with a corresponding timestamp of “00:05:23.”

In an embodiment, the system 102 may allow users 112 to interact with timestamps. For example, the user 112 may select a specific timestamp from the display device 114, and the processor 104 will immediately play the application video 118 starting from the exact moment corresponding to that timestamp. Said feature may enable user 112 to quickly locate and review the exact user interaction captured in the transcription by watching the associated video segment. For instance, if a user 112 wants to review the moment when the “Submit” button was clicked, he may select the timestamp say “00:05:23” from the transcription summary data 108. The processor 104 may then play the video 118 from that point, showing the specific interaction that corresponds to the transcription.

In an example, the processor 104 may continuously monitors the application video 118 as it records user interactions. When a user 112 performs an action, such as clicking a button, typing in a text field, or selecting a dropdown, the system 102 nay automatically logs the time of the action. This is done by referencing the internal video playback time, ensuring precise timestamps. Once the timestamps are generated, they are paired with the corresponding transcriptions in the transcription summary data 108. Each timestamp may be clickable, allowing user 112 to navigate directly to that point in the video by selecting the timestamp on the display device 114. Said feature may help users to save time when reviewing long videos 118 by letting them jump to the exact moment of interest instead of manually scrolling through the video to find specific actions

In an embodiment, the processor 104 may be configured to handle various types of user input actions. For example, the user input action may include a mouse click, a keyboard entry, a voice command, or a touch gesture. In one embodiment, if the user 116 interacts with a touch screen device, the processor 104 detects touch input, such as tapping on a button, and generates a transcription accordingly.

In some embodiments, the user input action may be triggered by voice commands. For example, the system 102 may be integrated with a voice recognition system, allowing users to control the application GUI using voice input. For example, if the user 112 says, “Click Submit,” the system 102 may recognize the voice input and generates a transcription such as “User clicked Submit button based on voice input.”

Further, in some embodiments, the system 102 may support multiple languages during the transcription process, allowing global users to transcribe and interact with videos in their preferred language. In one embodiment, the processor 104 may automatically detect the language of the application based on metadata and select the appropriate transcription language without requiring user input. For example, if the application video 118 pertains to a Spanish-language application 116, the processor 104 may generate transcriptions directly in Spanish.

In some embodiments, the processor 104 may integrate with external systems, such as project management tools or customer relationship management (CRM) platforms, to log and report user interactions captured during the transcription process. For instance, the transcription summary data 108 may be automatically exported to an external system for analysis or reporting purposes, enabling teams to track user behaviour or application performance.

In some embodiments, the processor 104 may capable of learning from user edits to improve the accuracy of future transcriptions. For example, if the user 112 frequently corrects a specific type of transcription error, the processor 104 may adjust the trained model 110 to avoid similar errors in future transcriptions. Additionally, the processor 104 may generate performance metrics based on the transcriptions and timestamps. For example, the system 102 may measure the time taken for specific user actions, such as how long it takes for a user to complete a form or navigate through multiple pages in the application.

In some embodiments, the system 102 may also support collaborative editing, where multiple users can view, edit, or comment on the transcription summary data 108 in real time. For instance, during a video review session, team members can collectively analyze and refine the transcriptions to ensure accuracy.

The system 102 may include additional features for analyzing complex user input actions, such as gestures or multi-step processes. In one example, if the user 112 performs a series of interactions like filling out a form and then clicking “Submit,” the processor 104 may generate a detailed transcription capturing each step in the process.

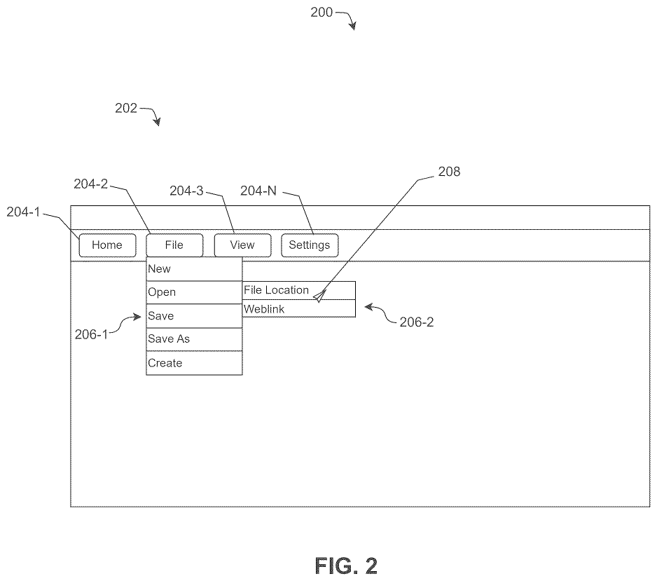

FIG. 2 illustrates a use case 200 depicting operation of the video transcription system, in accordance with one or more embodiments of the present subject matter. Shown in the use case 200 is a GUI 202 of a video of an application. The GUI 202 may include one or more actionable items 204-1 to 204-N. The actionable item 204-1 represents a HOME button, the actionable item 204-2 represents a FILE button, the actionable item 204-3 represents a VIEW button, and the actionable item 204-N represents a SETTINGS button.

Further, the GUI 202 includes a menu 206-1 provided under the FILE button, which is displayed when a user may hover a mouse on the FILE button. The menu 206-1 may include one or more entries for actions, such as New, Open, Save, Save As, and Create, providing the user to perform any of these actions. The GUI 202 further includes a menu 206-2 provided under OPEN entry in the menu 206-1, which is displayed when the user may hover the mouse on the OPEN entry. The menu 206-2 may include one or more entries, such as File Location and Weblink for opening content, say, a file, which may be stored locally on the user device 114 or may be in a cloud storage accessible using the weblink. Furthermore, the GUI 202 includes a user input action 208, which is a mouse click to perform the selection of a File Location entry in the menu 206-2.

In an example, a user seeking to open the file through the GUI 202 may first hover the mouse on the actionable item 204-2, i.e., FILE button. As a result of the mouse hover over the actionable item 204-2, the menu 206-1 is displayed to the user on the GUI 202. This display of the menu 206-1 is understood as a GUI action performed by the GUI 202 in response to the hover of the mouse over the FILE button.

Once the menu 206-1 is displayed to the user, the user may subsequently hover the mouse on the entry OPEN included in the menu 206-1. As a result, the menu 206-2 is displayed on the GUI 202. This display of the menu 206-2 is understood as a GUI action performed by the GUI 202 in response to the hover of the mouse over the OPEN entry.

Once the menu 206-2 is displayed to the user, the user may subsequently perform the user input action 208, i.e., the mouse clicks on the File Location entry in the menu 206-2 to select the file location from which the file is loaded in the application.

According to one or more embodiments of the present disclosure, the system 102 may be configured to analyse a plurality of GUI actions which occurred within a predefined time period from the user input action. Based on the analysis, the system 102 may determine one or more GUI actions which are related to the user input action. For example, in the present use case, the system 102 may analyse a plurality of GUI actions which would have occurred, say, 30 seconds prior to the user input action 208. Accordingly, the system 102 may determine that the GUI action of displaying the menu 206-1 and the menu 206-2 are related to the user action 208 as these aforementioned GUI actions help the user find the File Location entry.

Once the one or more GUI actions related to the user input action 208 are determined, the system 102 may be configured to generate one or more GUI action transcriptions corresponding to the one or more GUI actions and store them in the transcription summary data 108 corresponding to the video in the storage 106.

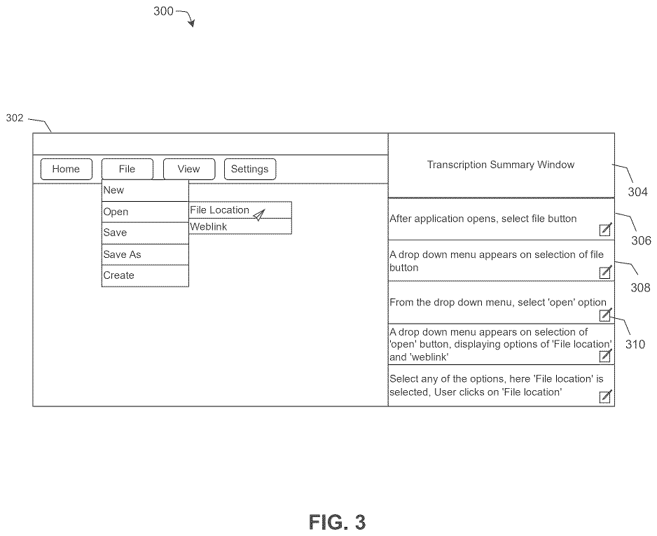

FIG. 3 illustrates a use case 300 depicting operation of the video transcription system, in accordance with one or more embodiments of the present subject matter. A GUI 302 is shown in the figure, which includes transcription summary data 108 in a transcription summary window 304. For instance, a transcription 306 which is a transcription for a user input action is depicted. Further, a GUI action transcription 308 is depicted.

According to aspects of the present disclosure, the system 102 may be configured to display an edit option 310 along with each of the transcriptions 306 and the GUI action transcriptions 308 which are displayed in the window 304. In some examples, the system 102 may receive a selection of the edit option 310, say, corresponding to the transcription 306. Accordingly, the system 102 may permit edit/deletion of the transcription 306. Once in the edit mode, the system 102 may edit/delete the transcription 306 based on a user input. For instance, the user may choose to edit the transcription or may choose to delete the transcription, if it is not useful. The system 102 may accordingly perform the edit or deletion of the transcription as per the user input.

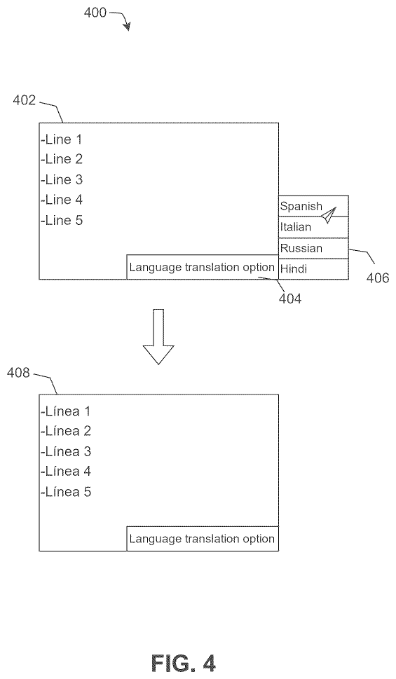

FIG. 4 illustrates a use case 400 depicting operation of the video transcription system, in accordance with one or more embodiments of the present subject matter. In some embodiments, the system 102 may be configured for translating the transcription summary data 108 into different languages.

In an example embodiment, the transcription summary data 108 may be rendered in a GUI 402. The transcription summary data 108 may include the user input actions and related GUI actions, depicted as Lines 1 to 5, transcribed from a video showing interactions with an application.

In the above embodiment, a language translation menu 404 is displayed on the GUI 402, showing a list of available languages 406. In an example, the user may select a preferred language from the list, such as Spanish, Italian, Russian, or Hindi, depending on the region or the user's language preferences.

Upon receiving the user's language selection, the system 102 may translate the transcription summary data 108 into the selected language. For example, if the user selects Spanish from the list of available languages, the system 102 translates the transcription summary data 108 into Spanish language. The translated transcription summary data is then displayed on the screen, for example, in the GUI 408, replacing the original English transcriptions. In some embodiments, the user may have the option to switch back and forth between the original and translated transcriptions for comparison or review.

In some embodiments, the translated transcription summary data may also be stored in the storage 106 alongside the original transcription data. This allows users to access both the original and translated versions of the transcription at all times. Furthermore, in some embodiments, the system 102 may automatically detect the user's preferred language, for example, based on their location or system settings, and may automatically translate the transcription summary data 108 into the preferred language. This may allow for seamless language translation without requiring manual input from the user.

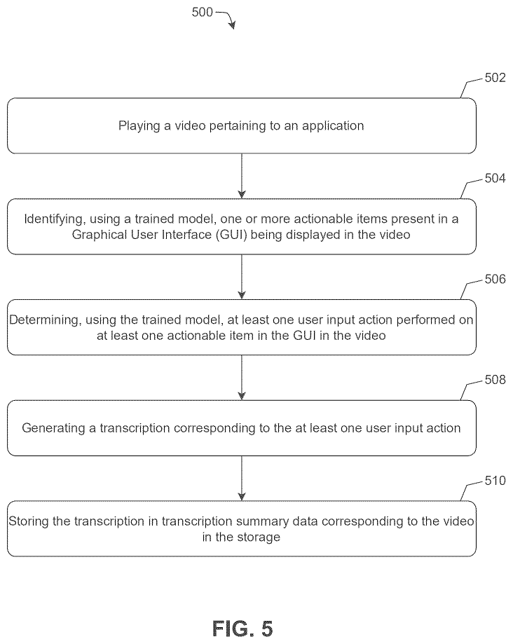

FIG. 5 illustrates a flowchart of a method 500 for transcribing videos, according to one or more embodiments of the present disclosure. FIG. 5 illustrates the method 500 for transcribing videos, specifically by identifying user input actions within a graphical user interface (GUI) and generating a corresponding transcription summary, according to embodiments of the present disclosure. The steps of the method 500, described in connection with the embodiments disclosed herein, may be embodied directly in hardware, in firmware, in a software module executed by a system, or in any practical combination thereof. In some embodiments, the method 500 may be implemented by a system 102 deployed in environments such as user interfaces for applications, web applications, or enterprise software to provide auto transcription of different types of application/training videos 118.

At step 502, the method 500 includes playing a video pertaining to an application 116. An application video 118 related to the application 116 may be a screen recording or a tutorial video that illustrates the Graphical User Interface (GUI) of the application. The application video 118 may pertains to a software program, a web application, or a mobile application. For instance, the application video 118 may depict a user 112 interacting with a banking application, showing how to fill out a transfer form, navigate through menus, or execute other relevant tasks. The application video 118 may be retrieved from various storage options, such as the local storage of a user device 114 or a cloud-based video repository, ensuring easy access to the necessary content. The step 502 may be performed by the processor 104 in the system 102.

At step 504, the method 500 includes identifying one or more actionable items present in the GUI displayed in the video. In an example, the actionable item may be any interactive element in the GUI, such as buttons, text boxes, drop-down menus, checkboxes, or links. The method 500 may use a trained model 110, such as a machine learning model or a deep learning model, to identify these actionable items in real time as the video plays.

For example, the method 500 may be applied to a video of a shopping website. The trained model may identify actionable items such as the “Add to Cart” button, “search bar”, and “quantity selector”. The trained model 110 may be trained on a large dataset of GUI elements to recognize various actionable items across different applications and domains. The step may be performed by the processor 104 in the system 102.

At step 506, the method 500 includes determining at least one user input action performed on the identified actionable item in the GUI of the application video 118. The user input action may be any interaction that the user performs, such as clicking a button, typing text into a field, or selecting an option from a menu. The trained model 110 may be used to detect and classify these user input actions based on the visual cues in the video.

For example, in an application video showing a user filling out a contact form, the method 500 may detect the user 112 typing their name into a text box, selecting their country from a drop-down menu, and clicking the “Submit” button. Further, in a scenario where the user 112 is placing an order through the food delivery app, the method 500 may detect the user 112 entering their address in the text box, choosing a restaurant from a list, and clicking on the “Place Order” button. The trained model 110 may utilize computer vision techniques to track the user's mouse movements and keystrokes, enabling precise detection of input actions. This step is again performed by the processor 104 in the system 102.

At step 508, the method 500 may generate a transcription corresponding to the detected user input action. The transcription may describe the action performed by the user 112 in natural language, such as “User clicked on Submit button” or “User entered text into Name field.” The transcription is automatically generated based on the user input action and the actionable item it is associated with. The step may be performed by the processor 104 in the system 102.

For instance, if the application video shows a user clicking on the “login” button in an e-commerce application, the generated transcription may read “User clicked Login button.” Similarly, if the video shows a user typing “John Doe” into a name field, the transcription may read “User entered John Doe into the Name field.”

At step 510, the method 500 may stores the generated transcription in transcription summary data 108 corresponding to the application video. The transcription summary data 108 may be saved in a storage 106, which may be a local drive in the system 102, a networked server, or a cloud storage system. The transcription summary data 108 may include multiple transcriptions generated for different user input actions in the video. The step may be performed by the processor 104 in the system 102.

For example, in an application video 118 showing a user browsing an online store, the transcription summary data 108 may store transcriptions like “User searched for ‘laptop’,” “User clicked Add to Cart,” and “User entered delivery address.” These transcriptions are linked to the application video 118 and may be retrieved for later analysis or review.

In an embodiment, the method 500 includes rendering the transcription summary data 108 on the display device 114, wherein the transcription summary data 108 comprises a plurality of transcriptions and/or a plurality of GUI action transcriptions. In an embodiment, a plurality of edit options may be provided corresponding to the plurality of transcriptions and/or the one or more of GUI action transcriptions are rendered along with the plurality of transcriptions and/or the one or more GUI action transcriptions on the display device 114. The user 112 may select of an edit option from the plurality of edit options. The user 112 is permitted with editing/deletion of the transcription/GUI action transcription corresponding to the selected edit option. Based upon the selected edit option based on a user input, the corresponding transcription/GUI action transcription may get edited/deleted the.

Further, in an embodiment, the method 500 includes determining a domain of the application based on metadata associated with the application video 118, wherein the metadata includes information about the domain of the application video 118. Further, the method 500 includes accessing the storage 106, wherein the storage 106 comprises one or more trained models 110 corresponding to one or more domains. The trained model 110 may be selected from the one or more trained models based on the domain of the application 118.

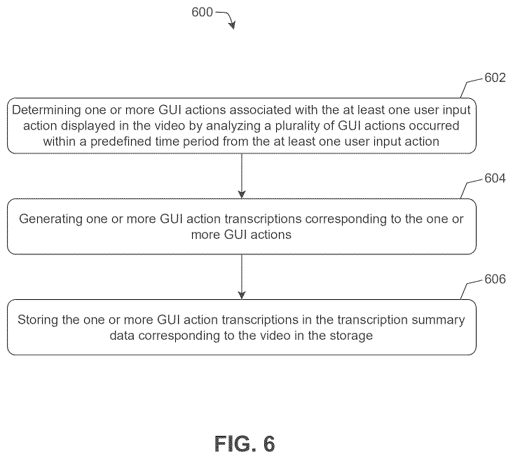

FIG. 6 illustrates a flowchart of a method 600 for transcribing videos, by determining and transcribing GUI actions associated with user input action according to one or more embodiments of the present disclosure. The method 600 may perform the transcription process by analyzing not only user input actions but also the corresponding GUI actions that occur before and subsequent to the user input action within a predetermined time interval. In an example, the GUI actions may be indicative of how the application 116 responds to user inputs, providing a more comprehensive understanding of the interaction.

At step 602, the method 600 starts by determining one or more GUI actions that are triggered by a user input action within the application video 118. Once the method 600 detects a user input, such as a mouse click or keyboard entry, it proceeds to analyze the GUI for any subsequent actions related to that input. Additionally, the method 600 may also analyzes the GUI actions that may have occurred prior to the user input action to gain context for the interaction. In an example, the one or more GUI actions includes detecting any changes in the GUI that happened within a predefined time period before the user input action, as well as subsequent actions that may occur after the user input action. The step may be performed by the processor 104 in the system 102.

In an example, method 600 may determine one or more GUI actions before the user input action. For example, if the user 112 may be filling out an online order form, the method 600 includes determining that the user 112 navigated to the order form page, selected items, and filled in the shipping information before clicking the “Place Order” button. These actions provide context for the user input. Further, the method 600 may be capturing the user input actions, such as clicking the “Place Order” button. The method 600 may be analysing the GUI for any changes that occur immediately after the user input action. For instance, after clicking the “Place Order” button, the user 112 may be redirected to a confirmation page, receives a success message, or encounters an error message (e.g., “Invalid payment details”).

For example, in an application video 118 depicting a user on an online banking platform, the user 112 may about to click the “Submit” button on a funds transfer form. Before the click, there may be GUI elements visible in a particular frame of the application video 118, including the filled “Amount” field, the selected recipient, and the “Submit” button. Within a predetermined timeframe for example say 3 seconds prior to the user input action, the user's interactions with the application video 118 may be analysed. For instance, the method 600 includes identifying that the user 112 has previously entered “600 USD” into the “Amount” field and selected a recipient from a drop-down menu. As the user 112 clicks the “Submit” button, the input action may be captured and the method 600 allows to correlate the click with the previous GUI state. Subsequent GUI Actions will be analyzed and determined after the click. The method 600 may analyse the GUI that occur within a predefined time frame after the user input action. For example, a confirmation message appears shortly after the click, stating, “Transfer Successful,” or that an error message appears, such as “Invalid Amount.

At step 604, the method 600 generates one or more GUI action transcriptions based on the identified GUI actions. These transcriptions describe the behavior or responses of the system following the user input, such as “Form submitted successfully,” or “Error: Missing required fields.” In an example, said transcriptions may be generated in natural language, providing a clear and concise summary of how the GUI reacted to the user's action. By generating these additional transcriptions, the method ensures that the context of the user's interaction in every frame of the application video 118 is fully documented. The step may be performed by the processor 104 in the system 102.

For example, consider a scenario in a banking application where a user is about to click the “Transfer Funds” button. Prior to the user's input action, there may be a display of tooltip beside the button stating, “Click here to transfer funds,” which guides the user on what to do next. The corresponding transcription for this GUI action would be “Tooltip displayed: ‘Click here to transfer funds”. Once the user clicks the “Transfer Funds” button, the GUI interface may respond by showing a confirmation dialog that states, “Transfer initiated. Please wait for confirmation.” This transcription documents the immediate response of the application to the user's input. By generating these transcriptions, the method 600 ensures that both the instructional context leading up to the user's interaction and the application's reaction afterward are accurately captured, providing a comprehensive understanding of the user experience within the application video 118.

Once the GUI action transcriptions are generated, they are stored at step 606 in the transcription summary data 108 alongside the user input action transcriptions. This structured data is stored in a persistent storage medium, such as a database, cloud storage, or a local repository, making it easy to access and review later. By storing both user input and GUI action transcriptions together, the method offers a detailed log of interactions, allowing users or analysts to trace the cause-and-effect sequence of actions within the application. The method 600 may ensure that the relationship between user inputs and GUI responses is captured, providing a complete transcription that accounts for both what the user did and how the application video 118 responded.

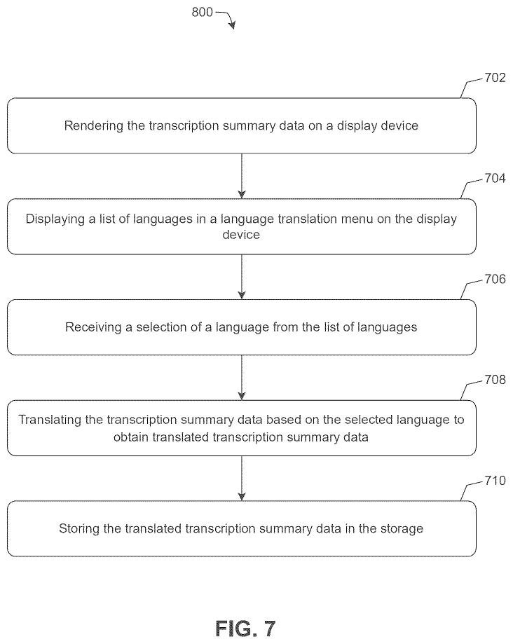

FIG. 7 is a flowchart illustrating a method 700 for translating transcription summary data into different languages, according to one or more embodiments of the present disclosure. In an embodiment, the method 700 may provide a powerful feature that enables users to translate the transcription data generated from user interactions and GUI actions into their preferred language, making the system 102 accessible to users in multilingual environments.

At step 702, the method 700 may include rendering the transcription summary data 108 on a display device 114. In an example, the display may be a part of a user interface on a desktop monitor, tablet, or smartphone, depending on the implementation. The data includes the transcriptions of user input actions (e.g., button clicks, form entries) and associated GUI actions (e.g., page loads, error messages). Initially, the transcription summary data may be presented in a default language, such as English.

In one example, the transcription summary data 108 may be displayed alongside the application video 118, in a scrollable pane, capturing each user interaction in natural language. For example, on the left side of the screen, the video of the banking session plays and, on the right, a transcription pane shows the transcription summary data 106 of said frame of the application video 118 being played. Consider an application video where a user interacts with an e-commerce website, adding items to their cart and checking out. The transcriptions summary data 108 rendered on the display device 114 include transcriptions like “User clicked on the ‘Add to Cart’ button”, “user selected ‘express shipping’ option”, “User clicked ‘checkout’ button.” The transcription is initially displayed in a default language, such as English, for all users.

At step 704, the method 700 provides a language translation menu, which is displayed on the same screen as the transcription summary data 108. The menu presents a list of available languages for translation, such as Spanish, French, German, or Hindi. At step 706, the method 700, the user may select a language from this list to translate the displayed transcription data into their preferred language. This step ensures that users from different linguistic backgrounds can access the transcription data in a language they understand.

In an example, to make the transcription available in different languages, a

dropdown menu may be rendered near the transcription pane. Said menu lists all supported languages that a user can choose from. Further, in an example, next to the transcription pane, there is a dropdown button labelled “Language.” When clicked, the user sees a list of available languages. The user can select any language from this list, prompting the method to translate the transcription into their preferred language. For example, in a global organization, a user from Spain viewing the transcription of an e-commerce site interaction may prefer to see the transcription in Spanish. By selecting “Spanish” from the menu, the user can translate the transcription summary into their native language for easier comprehension.

Once the user selects a language from the list at step 708, the method 700 translates the transcription summary data 108 into the chosen language. The translation process may be performed by a trained model 110 that accurately translates the transcription data while preserving the technical and contextual accuracy of the original.

In an example, the trained model 110 may be trained on extensive language pairs (e.g., English to French, English to Spanish) and is able to provide grammatically correct, context-aware translations. The model may leverage both neural networks and context-specific dictionaries to preserve the technical accuracy of terms like “Submit” or “Error: Invalid input.” For example, if the user selects French, the trained model 110 may translates phrases like, “User clicked Submit button” to “L'utilisateur a cliqué sur le bouton Soumettre”, “Error: Invalid email” to “Erreur:adresse email invalide”. Said translation may be performed in real time and displayed immediately in the transcription pane.

At step 710, the translated transcription summary data is stored in the system's storage 106 alongside the original transcription. This allows users to switch between languages or access both the original and translated versions of the transcription data at any time. The method 700 ensures that both versions are stored persistently, so the user 112 can choose which version to view based on their preferences or needs.

The method 700 enables seamless translation of transcription data, ensuring that global teams or users who speak different languages can access and interact with the transcription summary data in their native language. Said method may be useful for multinational companies or collaborative projects where team members speak different languages.

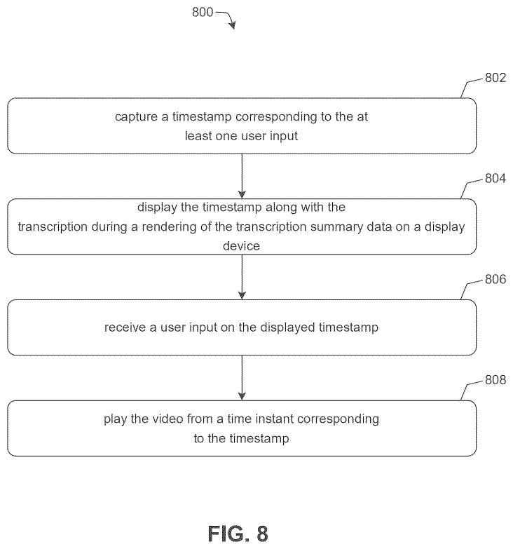

FIG. 8 is a flowchart illustrating a method 800 for capturing timestamps corresponding to user input actions and using those timestamps to enable playback of the video from specific time instants, according to one or more embodiments of the present disclosure. This method enhances the ability to review and analyse user interactions by associating each transcription with a specific moment in the video.

At step 802, the method 800 captures a timestamp for each user input action detected in the video. As the video plays and the system detects user interactions (such as mouse clicks or text entries), it records the exact moment in the video when each action occurs. For example, if a user clicks a “Submit” button at 00:05.50 in the video, this time instant is saved as a timestamp linked to the corresponding transcription.

At step 804, the method 800 displays these timestamps alongside the transcriptions in the transcription summary data. The transcription may read “User clicked Submit button,” and next to this, the timestamp “00:05:23” is displayed, indicating when this action occurred in the video. The timestamps help users quickly locate specific moments in the video and review exactly when each interaction took place.

The method 800 further enables interaction with the displayed timestamps at step 806. Users can click on or select any of the timestamps to play the video from that exact time instant. This feature allows for targeted playback, meaning users can jump to specific moments in the video without having to watch the entire recording. For example, selecting the timestamp “00:05:23” will cause the video to play from the moment when the user clicked the “Submit” button.

At step 808, the system plays the video from the selected timestamp, showing the user input action in context. This targeted playback feature is particularly useful for detailed reviews of user interactions, such as when conducting software testing, analyzing user experience, or verifying specific steps in a workflow. By allowing users to revisit specific moments, the system provides an efficient way to analyse key interactions and ensure that transcriptions accurately reflect the user's behavior.

The method 800 explains how to link transcription data with video timestamps, offering users a streamlined way to review specific actions in the video. Said method provides a deeper understanding of user interactions and helps ensure that the transcription data is both accurate and contextual. Thus, the method 800 enhances video review by capturing timestamps for each user input action and allowing users to quickly navigate to those moments during playback. This feature is valuable for scenarios requiring detailed analysis or verification of specific interactions in the video, making it easier for users to evaluate and understand the transcriptions in context.

The proposed solution may provide use of trained model to automatically translate transcription data in order to ensures that the translation is both quick and accurate. This eliminates the need for manual translation and ensures consistency in the transcriptions across languages. Further, the system provides transcription of both user input actions, prior and subsequent GUI actions happening in the application video in a precise and contextual manner. This ensures a complete record of interactions, which is especially useful in fields like software testing, user experience analysis, or workflow validation. By documenting the specific GUI responses to user actions, the system offers valuable insights into user behavior and system performance. Further, associating user interactions with precise timestamps allows developers and testers of the applications to pinpoint the exact moment where issues occurred in any application. This increases the accuracy of bug tracking and troubleshooting.

Other advantages of the proposed invention include Cross-Platform Implementation that is the invention can be integrated into desktop applications, web applications, or mobile applications, ensuring that users can utilize the transcription and translation features on any device. Further, the proposed system's ability to generate and translate transcriptions in real time allows for immediate feedback during user testing or training, enhancing the overall workflow efficiency.

The foregoing description refers to elements or nodes or features being “coupled”together. As used herein, unless expressly stated otherwise, “coupled” means that one element/node/feature is directly or indirectly joined to (or directly or indirectly communicates with) another element/node/feature, and not necessarily mechanically. Thus, although the drawings may depict one exemplary arrangement of elements directly connected to one another, additional intervening elements, devices, features, or components may be present in an embodiment of the depicted subject matter. In addition, certain terminology may also be used herein for the purpose of reference only, and thus are not intended to be limiting.

The foregoing detailed description is merely exemplary in nature and is not intended to limit the subject matter of the application and uses thereof. Furthermore, there is no intention to be bound by any theory presented in the preceding background, brief summary, or the detailed description.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the subject matter in any way. Rather, the foregoing detailed description will provide those skilled in the art with a convenient road map for implementing an exemplary embodiment of the subject matter. It should be understood that various changes may be made in the function and arrangement of elements described in an exemplary embodiment without departing from the scope of the subject matter as set forth in the appended claims. Accordingly, details of the exemplary embodiments or other limitations described above should not be read into the claims absent a clear intention to the contrary.

What is claimed is:

1. A system (102) for transcribing videos, the system (102) comprising:
a storage (106); and
at least one processor (104) coupled to the storage (106), the at least one processor (104) configured to:
play a video pertaining to an application;
identify, using a trained model, one or more actionable items present in a Graphical User Interface (GUI) being displayed in the video;
determine, using the trained model, at least one user input action performed on at least one actionable item in the GUI in the video;
generate a transcription corresponding to the at least one user input action; and
store the transcription in transcription summary data corresponding to the video in the storage (106).

2. The system (102) of claim 1, wherein the at least one processor (104) is configured to:
determine one or more GUI actions associated with the at least one user input action displayed in the video by analyzing a plurality of GUI actions occurred within a predefined time period from the at least one user input action;
generate one or more GUI action transcriptions corresponding to the one or more GUI actions; and
store the one or more GUI action transcriptions in the transcription summary data corresponding to the video in the storage (106).

3. The system (102) of claim 2, wherein the at least one processor (104) configured to:
render the transcription summary data on a display device, wherein the transcription summary data comprises a plurality of transcriptions and/or a plurality of GUI action transcriptions, and wherein a plurality of edit options corresponding to the plurality of transcriptions and/or the one or more of GUI action transcriptions are rendered along with the plurality of transcriptions and/or the one or more GUI action transcriptions on the display device;
receive a selection of an edit option from the plurality of edit options;
permit edit/deletion of the transcription/GUI action transcription corresponding to the selected edit option; and
edit/delete the transcription/GUI action transcription corresponding to the selected edit option based on a user input.

4. The system (102) of claim 1, wherein the at least one processor (104) is configured to:
render the transcription summary data on a display device;
display a list of languages in a language translation menu on the display device;
receive a selection of a language from the list of languages;
translate the transcription summary data based on the selected language to obtain translated transcription summary data; and
store the translated transcription summary data in the storage (106).

5. The system (102) of claim 1, wherein the at least one processor (104) is configured to:
determine a domain of the application based on metadata associated with the video, wherein the metadata includes information about the domain of the video;
access the storage (106), wherein the storage (106) comprises one or more trained models corresponding to one or more domains; and
select the trained model from the one or more trained models based on the domain of the application.

6. The system (102) of claim 1, wherein the at least one processor (104) is configured to:
capture a timestamp corresponding to the at least one user input;
display the timestamp along with the transcription during a rendering of the transcription summary data on a display device;
receive a user input on the displayed timestamp; and
play the video from a time instant corresponding to the timestamp.

7. The system (102) of claim 1, wherein the user input action comprises at least one of: a mouse clicks, a keyboard input, a click operation performed based on a voice input, and a data entry performed based on a voice input.

8. A method for transcribing videos, the method comprising:
playing a video pertaining to an application;
identifying, using a trained model, one or more actionable items present in a Graphical User Interface (GUI) being displayed in the video;
determining, using the trained model, at least one user input action performed on at least one actionable item in the GUI in the video;
generating a transcription corresponding to the at least one user input action; and
storing the transcription in transcription summary data corresponding to the video in the storage (106).

9. The method of claim 8, wherein the method comprising:
determining one or more GUI actions associated with the at least one user input action displayed in the video by analyzing a plurality of GUI actions occurred within a predefined time period from the at least one user input action;
generating one or more GUI action transcriptions corresponding to the one or more GUI actions; and
storing the one or more GUI action transcriptions in the transcription summary data corresponding to the video in the storage (106).

10. The method of claim 9, wherein the method comprising:
rendering the transcription summary data on a display device, wherein the transcription summary data comprises a plurality of transcriptions and/or a plurality of GUI action transcriptions, and wherein a plurality of edit options corresponding to the plurality of transcriptions and/or the one or more of GUI action transcriptions are rendered along with the plurality of transcriptions and/or the one or more GUI action transcriptions on the display device;
receiving a selection of an edit option from the plurality of edit options;
permitting editing/ deletion of the transcription/GUI action transcription corresponding to the selected edit option; and
editing/deleting the transcription/GUI action transcription corresponding to the selected edit option based on a user input.

11. The method of claim 8, wherein the method comprising:
rendering the transcription summary data on a display device;
displaying a list of languages in a language translation menu on the display device;
receiving a selection of a language from the list of languages;
translating the transcription summary data based on the selected language to obtain translated transcription summary data; and
storing the translated transcription summary data in the storage (106).

12. The method of claim 8, wherein the method comprising:
determining a domain of the application based on metadata associated with the video, wherein the metadata includes information about the domain of the video;
accessing the storage (106), wherein the storage (106) comprises one or more trained models corresponding to one or more domains; and
selecting the trained model from the one or more trained models based on the domain of the application.

13. The method of claim 8, wherein the method comprising:
capturing a timestamp corresponding to the at least one user input;
displaying the timestamp along with the transcription during a rendering of the transcription summary data on a display device;
receiving a user input on the displayed timestamp; and
playing the video from a time instant corresponding to the timestamp.

14. The method of claim 8, wherein the user input action comprises at least one of: a mouse clicks, a keyboard input, a click operation performed based on a voice input, and a data entry performed based on a voice input.

15. A computer-readable medium having computer-executable instructions stored thereon that, when executed by a processing system, cause the processing system to:
play a video pertaining to an application;
identify, using a trained model, one or more actionable items present in a Graphical User Interface (GUI) being displayed in the video;
determine, using the trained model, at least one user input action performed on at least one actionable item in the GUI in the video;
generate a transcription corresponding to the at least one user input action; and
store the transcription in transcription summary data corresponding to the video in the storage (106).

16. The computer-readable medium of claim 15, wherein the computer-executable instructions cause the processing system to:
determine one or more GUI actions associated with the at least one user input action displayed in the video by analyzing a plurality of GUI actions occurred within a predefined time period from the at least one user input action;
generate one or more GUI action transcriptions corresponding to the one or more GUI actions; and
store the one or more GUI action transcriptions in the transcription summary data corresponding to the video in the storage (106).

17. The computer-readable medium of claim 16, wherein the computer-executable instructions cause the processing system to:
render the transcription summary data on a display device, wherein the transcription summary data comprises a plurality of transcriptions and/or a plurality of GUI action transcriptions, and wherein a plurality of edit options corresponding to the plurality of transcriptions and/or the one or more of GUI action transcriptions are rendered along with the plurality of transcriptions and/or the one or more GUI action transcriptions on the display device;
receive a selection of an edit option from the plurality of edit options;
permit edit/deletion of the transcription/GUI action transcription corresponding to the selected edit option; and
edit/delete the transcription/GUI action transcription corresponding to the selected edit option based on a user input.

18. The computer-readable medium of claim 15, wherein the computer-executable instructions cause the processing system to:
render the transcription summary data on a display device;
display a list of languages in a language translation menu on the display device;
receive a selection of a language from the list of languages;
translate the transcription summary data based on the selected language to obtain translated transcription summary data; and
store the translated transcription summary data in the storage (106).

19. The computer-readable medium of claim 15, wherein the computer-executable instructions cause the processing system to:
determine a domain of the application based on metadata associated with the video, wherein the metadata includes information about the domain of the video;
access the storage (106), wherein the storage (106) comprises one or more trained models corresponding to one or more domains; and
select the trained model from the one or more trained models based on the domain of the application.

20. The computer-readable medium of claim 15, wherein the computer-executable instructions cause the processing system to:
capture a timestamp corresponding to the at least one user input;
display the timestamp along with the transcription during a rendering of the transcription summary data on a display device;
receive a user input on the displayed timestamp; and
play the video from a time instant corresponding to the timestamp.
